(19) United States
(12) Patent Application Publication
(10) Pub. No.: US 2020/0263824 A1
(43) Pub. Date: Aug. 20, 2020

(54) VISIBLE, REMOVABLE FILTER FOR WATER TOOLS

(71) Applicant: HUSQVARNA AB, HUSKVARNA (SE)

(72) Inventors: Mattias Müller-Braun, Neu-Ulm (DE); Reiner Frey, Neu-Ulm (DE); Tobias Schlegel, lllerkirchberg (DE)

(21) Appl. No.: 16/649,314

(22) PCT Filed: Feb. 15, 2018
(86) PCT No.: PCT/EP2018/053780

§ 371 Date: Mar. 20, 2020

(30) Foreign Application Priority Data
Sep. 27, 2017 (DE) 10 2017 009 041.6

(51) Int. Cl. F16L 55/24; F16L 33/30

(52) U.S. Cl. CPC F16L 55/24; B01D 29/117; F16L 33/30

(57) ABSTRACT

A hose connector (100) for water filtering includes a connector port (102) adapted to receive water at an inlet (104). The hose connector (100) includes an outlet (106) to allow water to leave the connector port (102). The hose connector (100) includes a filter (110) coupled to the connector port (102) at the inlet (104). The hose connector (100) is characterized in that the filter (110) is adapted to be inserted inside the inlet (104). The hose connector (100) includes at least one recess (112). The filter (110) has a first end (302) and a second end (304). Further, the filter (110) includes a flange portion (306) towards the first end (302), such that the flange portion (306) has at least one protrusion (308) adapted to engage the at least one recess (112).

### TECHNICAL FIELD

The present disclosure relates to filters for water tools. More specifically, the present disclosure relates to a visible and removable filter for water tools.

### BACKGROUND

Watering tools generally include a filter to check any undesired particles such as impurities and the like present in water. But due to its role to check the impurities, the filter needs to be cleaned regularly as per use for a longer lifetime. However, conventional watering tools prove cumbersome for a common user for engaging with the filter due to multiple reasons.

The reasons which make using the conventional watering tools, and filters used therewith, difficult range from low access to recognizability of the filters. This invariably leads to indifferent use of the filter with less emphasis and attention to proper cleaning of the filter. Moreover, at times the filter maybe located substantially inside the watering tools thereby requiring application of some tools to remove them, if possible.

An example of a connector system is provided by WO2010/127815 (hereinafter referred to as '815 reference). The '815 reference provides a connector piece for a click-on connector system used in watering. The connector piece includes a connector nipple. Further, a sealing element is arranged in the connector piece which automatically blocks the flow path through the connector piece if no connector sleeve is clicked on. However, when a connector sleeve is clicked onto the connector nipple, there is a lift-off of the sealing element in the interior of the connector piece off the sealing surface and therefore release of the flow path.

The filter, as used conventionally, also needs to be provided with a means for cleaning when not in use. Further, these improvements are expected to be provided without increasing the number of parts or components of the water tool, especially the filter. Thus, an improved filter for water tools is required.

### SUMMARY

In view of the above, it is an objective of the present invention to solve or at least reduce the drawbacks discussed above. The objective is at least partially achieved by a hose connector. The hose connector includes a connector port adapted to receive water at an inlet. The hose connector includes an outlet to allow water to leave the connector port. The hose connector includes a filter coupled to the connector port at the inlet. The hose connector is characterized in that the filter is adapted to be inserted inside the inlet. The hose connector includes at least one recess. The filter has a first end and a second end. Further, the filter includes a flange portion towards the first end, such that the flange portion has at least one protrusion adapted to engage the at least one recess. Thus, the present disclosure provides a simple, compact and convenient filter which can be removably engaged with a typical hose connector.

According to an embodiment of the present invention, the hose connector is a water nipple. Further, the filter is compatible with different types of the water nipples increasing versatility of application of the filter.

According to an embodiment of the present invention, the filter is configured to be inserted with a cleaning needle at the second end. The cleaning needle may be used to clean nozzles etc. of watering tools.

According to an embodiment of the present invention, the filter is configured to be removably engaged with the at least one recess. As elaborated earlier, any maintenance or even cleaning operation of the filter would preferably require the filter to be removable as per need.

According to an embodiment of the present invention, the filter is readily removable with human intervention. This obviates need of any complex tool or equipment to remove the filter thereby making it convenient for a common user.

According to an embodiment of the present invention, the filter is made as a single unit. By manufacturing the filter as a single unit, the filter may provide benefits such as lower maintenance costs, and ease of replacement, if required.

According to an embodiment of the present invention, the filter is made of a plastic material. Preference for the plastic material takes into account lifetime and implementation needs of the filter. Also, as the filter is in contact with water, plastics typically provide advantages over metal materials.

According to an embodiment of the present invention, the filter has a plurality of holes towards the second end. The plurality of holes is provided to serve as water outlet and filter out any impurities (in the water) around the second end.

According to an embodiment of the present invention, the filter is visibly distinguishable from the connector port. This make it easy for the common user to identify and engage with the filter, whenever required.

Other features and aspects of this invention will be apparent from the following description and the accompanying drawings

### BRIEF DESCRIPTION OF THE DRAWINGS

The invention will be described in more detail with reference to the enclosed drawings, wherein:

FIG. 1 shows a perspective view of a hose connector along with a filter, in accordance with an embodiment of the present invention;

FIG. 2 shows a perspective view of a hose connector without the filter, in accordance with an embodiment of the present invention;

FIG. 3 shows a perspective view of the filter, in accordance with an embodiment of the present invention;

FIG. 4 shows a side view of the filter, in accordance with an embodiment of the present invention;

FIG. 5 shows a front view of the filter along with the plurality of holes, in accordance with an embodiment of the present invention;

FIG. 6 shows a front cross-sectional view of the filter along with the plurality of holes, in accordance with an embodiment of the present invention;

FIG. 7 shows a side cross-sectional view of the filter engaged with the hose connector, in accordance with an embodiment of the present invention;

FIG. 8 shows a side view of the filter along with a cleaning needle, in accordance with an embodiment of the present invention; and

FIG. 9 shows a perspective view of the filter along with the cleaning needle, in accordance with an embodiment of the present invention.

### DESCRIPTION OF EMBODIMENTS

The present invention will be described more fully hereinafter with reference to the accompanying drawings, in which example embodiments of the invention incorporating one or more aspects of the present invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. For example, one or more aspects of the present invention can be utilized in other embodiments and even other types of structures and/or methods. In the drawings, like numbers refer to like elements.

Certain terminology is used herein for convenience only and is not to be taken as a limitation on the invention. For example, “upper”, “lower”, “front”, “rear”, “side”, “longitudinal”, “lateral”, “transverse”, “upwards”, “downwards”, “forward”, “backward”, “sideward”, “left,” “right,” “horizontal,” “vertical,” “upward”, “inner”, “outer”, “inward”, “outward”, “top”, “bottom”, “higher”, “above”, “below”, “central”, “middle”, “intermediate”, “between”, “end”, “adjacent”, “proximate”, “near”, “distal”, “remote”, “radial”, “circumferential”, or the like, merely describe the configuration shown in the Figures. Indeed, the components may be oriented in any direction and the terminology, therefore, should be understood as encompassing such variations unless specified otherwise.

In the drawings and specification, there have been disclosed preferred embodiments and examples of the invention and, although specific terms are employed, they are used in a generic and descriptive sense only and not for the purpose of limitation of the scope of the invention being set forth in the following claims.

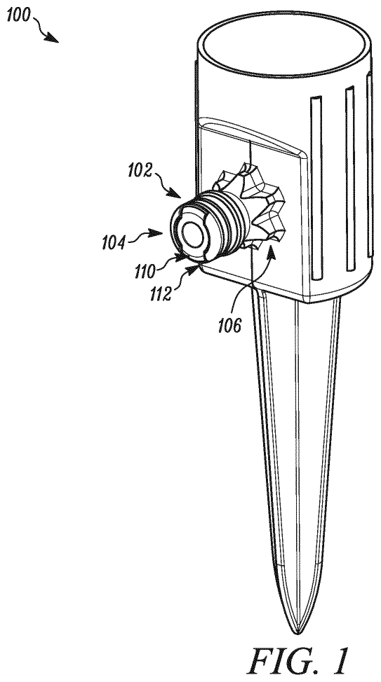

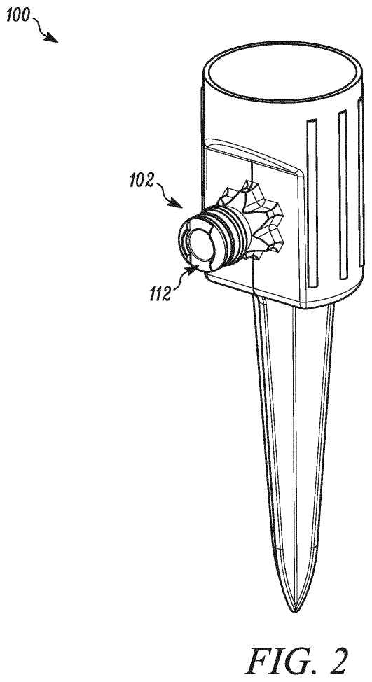

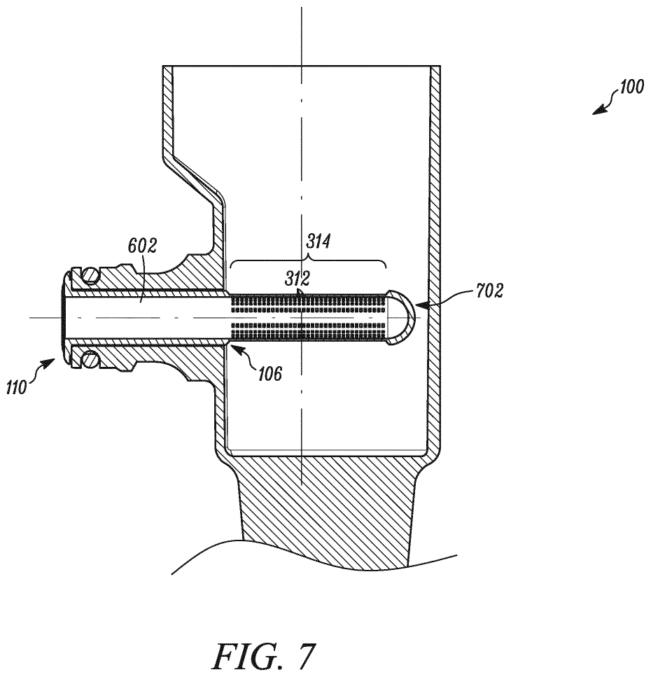

FIG. 1 illustrates a hose connector 100. The hose connector 100 includes a connector port 102 adapted to receive water at an inlet 104. The hose connector 100 includes an outlet 106 (shown in FIG. 7) to allow water to leave the connector port 102. The hose connector 100 includes a filter 110 coupled to the connector port 102 at the inlet 104. The filter 110 is adapted to be inserted inside the inlet 104. The hose connector 100 includes at least one recess 112 (shown in FIG. 2).

The filter 110 of the present disclosure includes two recesses 112. The filter 110 may normally be covering the recesses 112 in order to provide a desired waterproof connection for engaging a hose (not shown) with the hose connector 100, particularly with the filter 110. Further, the size, position, and arrangement of the recess 112 may be primarily dependent upon the filter 110 among other factors. This will allow a secure connection between the recess 112 and the filter 110 and thereby lead to the watertight connection. In a preferred embodiment, the hose connector 100 is a water nipple or any similar water tool as known or used in the relevant art.

FIG. 2 illustrates the hose connector 100 without the filter 110. It should be contemplated that the filter 110 is not shown to illustrate the geometry of the hose connector 100 in a better manner. As shown, the filter includes two recesses 112, however more recesses have been contemplated. The recesses 112 are accessible from outside the hose connector 100. This configuration may be due to removal of the filter 110, maybe for cleaning or like purposes. Either the filter 110 or the recess 112 may need to be cleaned as expected in case of longer operations. It shall be understood that the hose connector 100 may readily be utilized even without the application of the filter 110, in case desired by a user. The filter 110 is visibly distinguishable from the connector port 102. This is preferred in order to make it stand out from the connector port 102 or the at recess 112. The filter 110 may be provided with different colors or patterns or textures or any other means known in the art for making it easily distinguishable from the connector port 102 or any part thereof.

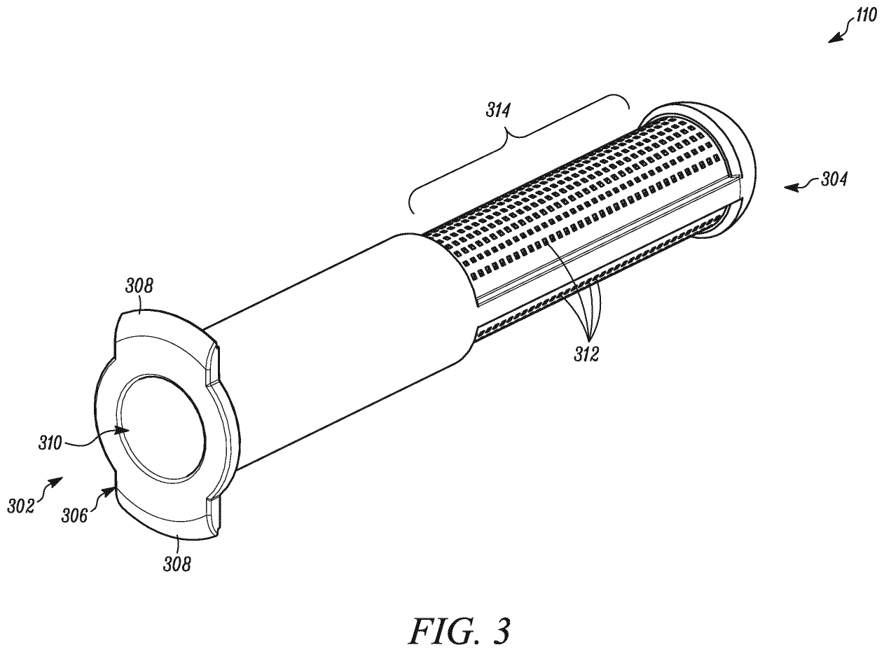

The filter 110, preferably the flange portion 306 (shown in FIG. 3), is visibly distinguishable from the connector port 102. Compared to conventional watering tools which are devoid of such visible features, the filter 110 of the present disclosure allows regular and timely maintenance of the filter 110, particularly due to the ease of removal along with visibly distinguishable nature of the filter 110. Thus, the visibly distinguishable filter 110 serves as an indicator for the user to attend to the filter 110 or any other part of the hose connector 100.

FIG. 3 illustrates the filter 110. The filter 110 has a first end 302 and a second end 304. Further, the filter 110 includes a flange portion 306 towards the first end 302. The flange portion 306 has at least one protrusion 308 adapted to engage the recess 112. The protrusions 308 are placed at diametrically opposite ends for ease of insertion or removal of the filter 110 into the recess 112. The flange portion 306 allows the user to engage with the filter 110 engaged with the hose connector 100 in case of any need for removal of the filter 110. The filter 110 has a central opening 310 to engage with the hose, when the filter 110 is engaged with the recess 112.

The filter 110 is configured to be removably engaged with the recess 112. Thus, the user may readily gain access to the filter 110 as would be required for regular cleaning purposes. Moreover, the filter 110 is readily removable just with human intervention, even without a need of any tool or equipment. This feature is readily possible as the filter 110 may be manufactured as a single unit which provides handling and operational benefits. The single unit also reduces the disadvantages of large number of parts and maintenance required. Additionally, or alternatively, the filter 110 may be made as a modular unit, preferably the flange 306 or other components of the filter 110 may be readily detachable and later-on refitted as per requirement. This further allows replacement or servicing of any part(s) of the filter 110 such as the flange 306 which may be susceptible to wear and tear during working life of the filter 110.

The filter 110 has a plurality of holes 312 (or simply, holes 312) towards the second end 304. A filtering zone 314 is defined by the holes 312. The number or type or arrangement of the holes 312 may be dependent upon the type of application of the filter 110, or even quality of water involved with the application.

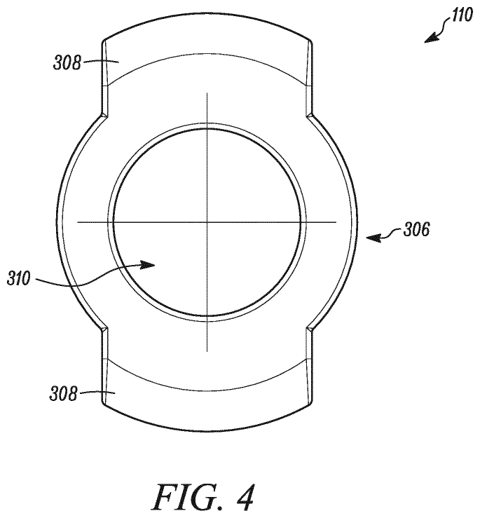

FIG. 4 illustrates the filter 110 with the central opening 310. The central opening 310 of the filter 110 may be designed taking into account common types of the hoses, as used or known in the art, for a secure, tight connection between the central opening 310 and the hose. In an embodiment, the filter 110 is made of a plastic material. The material may also be silicon, rubber or any material as would be applicable with implementation of the present disclosure.

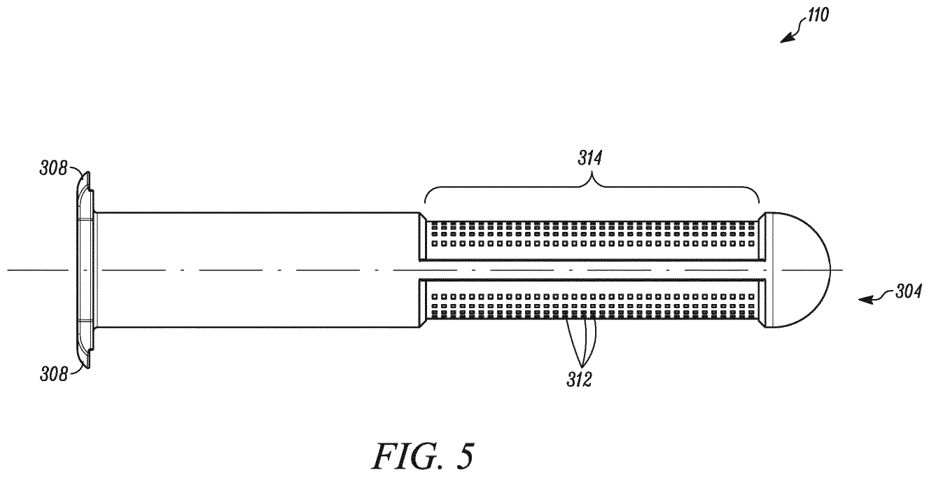

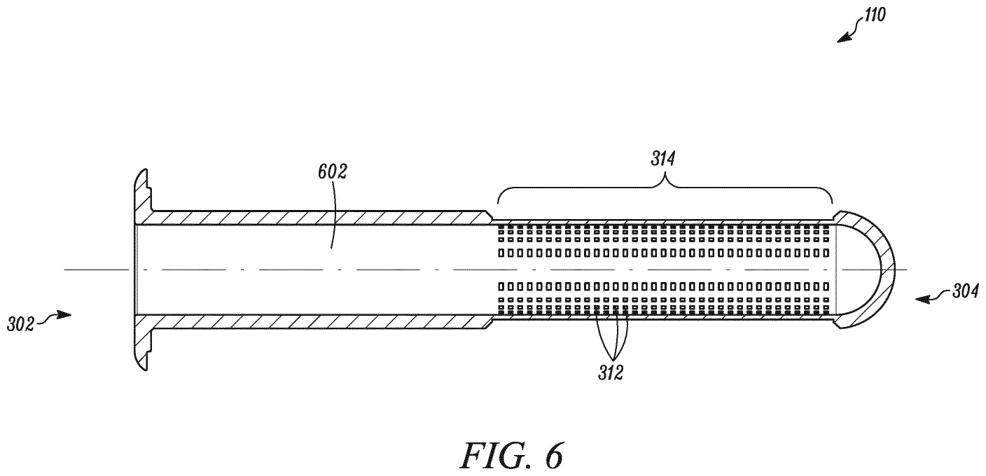

FIGS. 5 and 6 illustrate the filter 110 along with the holes 312. The specifications such as length, breadth, height, and radius of the filter 110 may be dependent upon the hose connector 100. Particularly, FIG. 6 shows the internal arrangement of the filter 110 showing a passage 602 for movement of the water from the first end 302 to the second end 304 of the filter 110. The second end 304 is generally plugged or water-tight to check any leakage from the second end 304. Further, the second end 304 allows the water to move towards the holes 312 for desired filtering of any unwanted particles (i.e. impurities) from the water by the filter 110.

FIG. 7 illustrates the filter 110 engaged with the hose connector 100. As shown, the filter 110 engages fully with the one recess 112 till an end point 702 of the hose connector 100. Preferably, the filtering zone 314 may come in contact with the outlet 106 of the hose connector 100. This ensures filtering of the water by each of the holes 312 of the filtering zone 314 for desired working of the filter 110. Alternatively, depending upon the application or type of the filter 110, some, many or all of the holes 312 of the filtering zone 314 may be shielded by the inlet 104 of the hose connector 100.

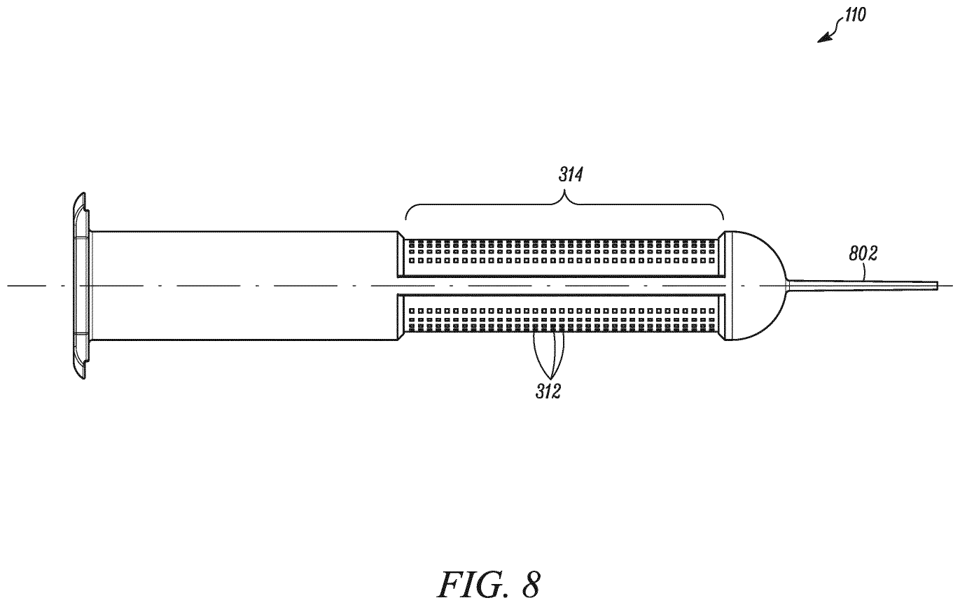

FIG. 8 illustrates the filter 110 along with a cleaning needle 802. The filter 110 is configured to be inserted with the cleaning needle 802 at the second end 304. The cleaning needle 802 may be required to remove any unwanted material from the hose connector 100 or any other parts such as nozzles which are generally susceptible to foreign impurities during working life of the hose connector 100 or the filter 110. Preferably, the cleaning needle 802 remains connected around the second end 304 of the filter 110, but alternatively, the cleaning needle 802 may be removably attached with the filter 110.

The filter 110 with the cleaning needle 802 around the second end 304 prevents loss of the cleaning needle as compared to conventional watering tools. Further, in order to use the cleaning needle 802, the filter 110 is removed from the recess 112 of the hose connector 100. This makes the filter 110 free of any water and thereby ready for any cleaning action. Then, the filter 110 along with the cleaning needle 802 may be used for cleaning any part (say nozzles) of the hose connector 100.

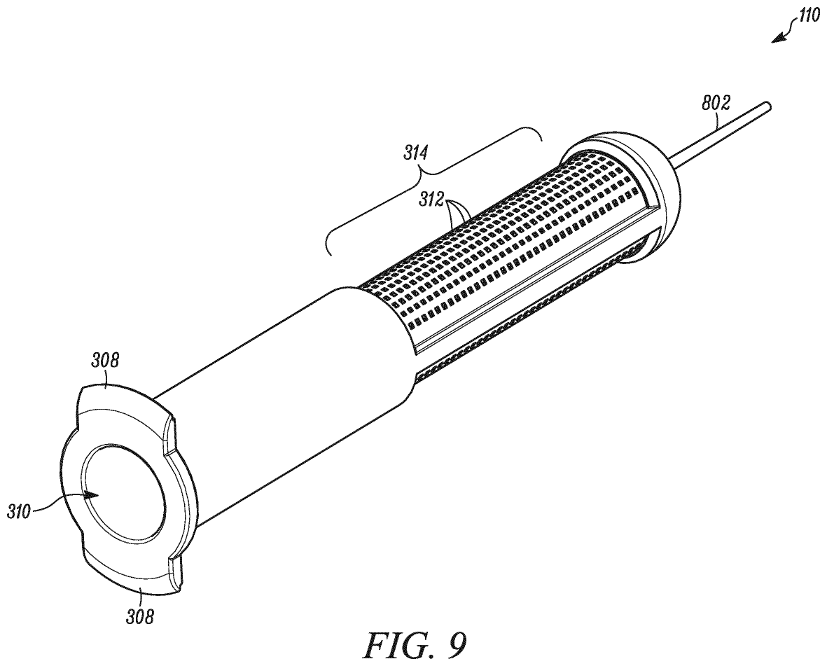

FIG. 9 illustrates another view of the filter 110 with respect to the cleaning needle 802. The cleaning needle 802 is applicable for non-use cases of the filter 110. Once the filter 110 is disengaged from the hose connector 100, the cleaning needle 802 may be used to clean the filter 110, particularly around the filtering zone 314 or the second end 304. The present disclosure may be readily implemented even without the application of the cleaning needle 802.

In the drawings and specification, there have been disclosed preferred embodiments and examples of the invention and, although specific terms are employed, they are used in a generic and descriptive sense only and not for the purpose of limitation of the scope of the invention being set forth in the following claims.

### LIST OF ELEMENTS

100 Hose Connector
102 Connector Port
104 Inlet
106 Outlet
110 Filter
112 Recess
302 First End
304 Second End
306 Flange Portion
308 Protrusion
310 Central Opening
312 Holes
314 Filtering Zone
602 Passage
702 End Point
802 Cleaning Needle

1. A hose connector (100) comprising:
a connector port (102) adapted to receive water at an inlet (104);
an outlet (106) to allow water to leave the connector port (102);
a filter (110) coupled to the connector port (102) at the inlet (104);
characterized in that:
the filter (110) is adapted to be inserted inside the inlet (104);
the hose connector (100) includes at least one recess (112); and
the filter (110) has a first end (302) and a second end (304), wherein the filter (110) includes a flange portion (306) towards the first end (302), such that the flange portion (306) has at least one protrusion (308) adapted to engage the at least one recess (112).

2. The hose connector (100) of claim 1, wherein the hose connector (100) is a water nipple.

3. The hose connector (100) of claim 1, wherein the filter (110) is configured to be inserted with a cleaning needle (802) at the second end (304).

4. The hose connector (100) of claim 1, wherein the filter (110) configured to be removably engaged with the at least one recess (112).

5. The hose connector (100) of claim 1, wherein the filter (110) is readily removable with human intervention.

6. The hose connector (100) of claim 1, wherein the filter (110) is made as a single unit.

7. The hose connector (100) of claim 1, wherein the filter (110) is made of a plastic material.

8. The hose connector (100) of claim 1, wherein the filter (110) has a plurality of holes (312) towards the second end (304).

9. The hose connector (100) of claim 1, wherein the filter (110) is visibly distinguishable from the connector port (102).
